(19) United States
(12) Patent Application Publication
(10) Pub. No.: US 2024/0173691 A1
(43) Pub. Date: May 30, 2024

(54) MODULAR REACTOR CONFIGURATION FOR PRODUCTION OF CHEMICALS WITH ELECTRICAL HEATING FOR CARRYING OUT REACTIONS

(71) Applicant: SHELL USA, INC., Houston, TX (US)

(72) Inventors: Ram Ratan RATNAKAR, Houston, TX (US); Vemuri BALAKOTAIAH, Houston, TX (US); Albert Destrehan HARVEY, III, Houston, TX (US)

(73) Assignee: SHELL USA, INC., Houston, TX (US)

(21) Appl. No.: 18/551,678

(22) PCT Filed: Apr. 13, 2022
(86) PCT No.: PCT/EP2022/059896

§ 371 Date: Sep. 21, 2023

Related U.S. Application Data
(60) Provisional application No. 63/175,384, filed on Apr. 15, 2021.

(51) Int. Cl. B01J 19/32; B01J 19/00

(52) U.S. Cl. CPC B01J 19/32; B01J 19/0013; B01J 2219/00038; B01J 2219/0004; B01J 2219/00135

(57) ABSTRACT

Novel modular reactor configurations utilizing resistance heating elements are provided. The resistance heating elements pass through the reaction zone of reactor modules and conduct electricity thereby providing resistance heating in the reaction zone to facilitate the conversion of the reactants to products when reactants are present in the reaction zone. The resistance heating elements may be configured as plurality of wires, a plurality of plates, wiremesh, gauze, and/or a metallic monolith.

### FIELD OF THE INVENTION

The present invention relates to a modular reactor configuration comprising at least one electrically heating element and to a method of performing a process at high temperature, comprising introducing at least one gaseous reactant into said reactor configuration. The reactor and method are useful in many industrial scale high temperature gas conversion and heating technologies.

### BACKGROUND OF THE INVENTION

Problems with global warming and the need to reduce the world's carbon footprint are currently high on the political agenda. In fact, solving the global warming problem is regarded as the most important challenge facing mankind in the 21st century. The capacity of the earth system to absorb greenhouse gas emissions is already exhausted, and under the Paris climate agreement, current emissions must be fully stopped until around 2070. To realize these reductions, at least a serious restructuring of industry is needed, away from conventional energy carriers producing CO₂. This decarbonization of the energy system requires an energy transition away from conventional fossil fuels such as oil, natural gas, and coal. A timely implementation for the energy transition requires multiple approaches in parallel. For example, energy conservation and improvements in energy efficiency play a role, but also efforts to electrify transportation and industrial processes. After a transitional period, renewable energy production is expected to make up most of the world's energy production, which will for a significant part consist of electricity.

While there are various small distributed sources for CO₂ emissions (such as vehicles, humans/animals etc. leading to significant cumulative amounts), the primary emission source are power plants or chemical manufacturing plants, where fossil fuels are traditionally burnt in a combustion furnace to generate electricity or supply the required heat for carrying endothermic reactions. For example, current ethane cracking technology releases about 1.2 moles of CO₂ per mole of ethylene produced into the atmosphere. In other words, a world-class ethane cracker, producing 1 million tons per annum (MTA) ethylene, releases approximately 1.800 MTA CO₂ into the atmosphere. Similar amounts of CO₂ are emitted from other endothermic processes such as pyrolysis or cracking of hydrocarbons (e.g. ethane, propane or naphtha) to value-added hydrocarbon products (such as ethylene, propylene and other olefins); reverse water-gas shift (RWGS) reaction to convert CO₂ to CO using hydrogen; dry methane reforming (DMR) reaction and steam methane reforming (SMR) reactions to make synthesis gas; pyrolysis of methane to produce high quality hydrogen and carbon; and various adsorption-desorption processes.

As renewable power costs are already low in certain regions of the world, technologies using electrically heated reactors and installations can be attractive to replace conventional hydrocarbon-fired heated reactors and high duty heating operations. Forecasted power prices and costs of CO₂ will increase the economic attractiveness of these reactors even more.

Electricity is the highest grade of energy available. When designing an efficient industrial process, which converts electrical energy into chemical energy, several options can be considered. These options are electrochemistry, cold plasmas, hot plasmas or thermally. In small scale laboratory settings, electrical heating is already being applied for many types of processes focusing on chemistry and material aspects. However, when the options are considered for designing chemical (conversion) technologies at an industrial scale, such as gas conversion, each of those options comes with certain complexities related to design and scale-up of reactor configuration and material requirements. This is especially the case when chemical conversion processes are highly endothermic, as the required heat flux and temperature levels are high. In the industry there is a need for electrification technologies that are suitable for endothermic chemical reactions and heating technologies at industrial scale.

Prior art systems used for these and other endothermic reactions are typically based on the internal flow of reactant gases through empty or catalyst packed tubes, where the required heat is supplied through the tube walls by burning of fossil fuels in a combustion furnace or by direct heat transfer through heat exchangers. For processes where the heat flux requirement is high, the requisite heat may be obtained through combustion furnaces that comprise of a closed refractory space with fuel burners providing heat via radiative transfer to the reactor tube walls. Therefore, in addition to CO₂ emissions, the prior art technology for endothermic processes based on burning fossil fuels in the furnaces present several other disadvantages such as lower thermal efficiency of the reactor (as low as 30-40%) and higher start-up and shutdown times (order of tens of hours to a few days). While additional process integration (such as utilization of heat content of exit streams) may lead to eventual increase in thermal efficiency, these other deficiencies are still present.

Since the capital cost of combustion furnaces decreases with scale, commercial size of prior art systems are large and flexibility in equipment turndown is sacrificed. As a result of the large size and singular nature of these prior art systems, the entire furnace unit requires periodic shutdown and cooldown in order to mitigate operational and/or safety issues related to continuous operation. For example, standard operation of these conventional systems results in the coke buildup on the inner tube wall, which commonly occurs when the furnace is operated at high temperature. The build-up of coke on reactor walls causes a reduction in heat flux (i.e., heat supply from solid to gas), leading to lower conversion and increase in pressure drop over time. This build-up also increases the external tube wall temperatures, which may potentially lead to tube failure due to metallurgical overheating and thermal stress (or reduce time for failure). Furthermore, the heat flux may not be uniform depending on the number of fuel burners, which necessitates the use of larger number of burners and optimization of their location for spatial uniformity in heat flux.

US2016288074 describes a furnace for steam reforming a feed stream containing hydrocarbon, preferably methane, having: a combustion chamber, a plurality of reactor tubes arranged in the combustion chamber for accommodating a catalyst and for passing the feed stream through the reactor tubes, and at least one burner which is configured to burn a combustion fuel in the combustion chamber to heat the reactor tubes. In addition, at least one voltage source is provided which is connected to the plurality of reactor tubes in such a manner that in each case an electric current which heats the reactor tubes to heat the feedstock is generable in the reactor tubes.

US2017106360 describes how endothermic reactions may be controlled in a truly isothermal fashion with external heat input applied directly to the solid catalyst surface itself and not by an indirect means external to the actual catalytic material. This heat source can be supplied uniformly and isothermally to the catalyst active sites solely by conduction using electrical resistance heating of the catalytic material itself or by an electrical resistance heating element with the active catalytic material coating directly on the surface. By employing only conduction as the mode of heat transfer to the catalytic sites, the non-uniform modes of radiation and convection are avoided permitting a uniform isothermal chemical reaction to take place.

The prior art approaches have their unique challenges, capabilities and/or are based on combining combustion heating with linear electrical heating. Therefore, there is still a need for more and other options for electrical heating technology that can for example be applied for large scale chemical processes.

The present disclosure provides a solution to said need. This disclosure relates to electrified gas conversion technologies at industrial scale, achieving high process efficiencies, and being relatively simple with low overall cost.

### SUMMARY OF THE INVENTION

It has been found that limitations present in the prior art systems may be overcome through the use of novel reactor configurations where the use of a combustion furnace to supply the required heat for endothermic process is replaced by electrical heating (preferably using renewable power). Such novel reactor configurations not only mitigate the drawbacks of the prior art systems, but also includes additional advantages including modular flexibility and the ease of scale-up.

Accordingly, the present disclosure relates to a novel reactor system that arranges the heating elements such that the heat supply to the gas is uniform and can be adjusted based on the gas flow rate, reaction enthalpy and reaction kinetics.

In an embodiment, a modular reactor system for carrying out endothermic reactions comprises at least one module, wherein each module further comprises: (a) a plurality of wall sections positioned to encompass a heating zone inside a channel configured to allow a fluid to flow through the heating zone; (b) a power source; and (c) at least one resistance heating element passing through the reaction zone in mechanical connection with the wall sections and in electrical connection with the power source. In some embodiments, the at least one resistance heating element is in electrical isolation from the wall sections. In some embodiments, the reactor system is configured to allow for the flow of a fluid containing one or more reactants. In some embodiments, the heating zone is suitable for conversion of the reactants to products when reactants are present in the fluid. In some embodiments, the resistive heating element of each module is configured to generate resistance heating in the reaction zone such that its temperature can be adjusted to a required reaction temperature range. In some embodiments, the at least one resistance heating element comprises a configuration selected from a group consisting of a plurality of wires, a plurality of plates, wiremesh, gauze, and a metallic monolith.

The features and advantages of the invention will be apparent to those skilled in the art. While numerous changes may be made by those skilled in the art, such changes are within the spirit of the invention.

### BRIEF DESCRIPTION OF THE DRAWINGS

A more particular description of the invention, briefly summarized above, may be had by reference to the embodiments thereof which are illustrated in the appended drawings and described herein. It is to be noted, however, that the appended drawings illustrate only some embodiments of the invention and therefore not to be considered limited of its scope for the invention may admit to other equally effective embodiments.

FIG. 1 shows isometric views of different types of heating elements configurations disclosed herein, including representative examples of (a) parallel wires, (b) parallel plates, (c) metallic monolith and (d) wiremesh/gauze reactor configurations.

FIG. 2 shows an isometric view of (a) a single modular unit of the disclosed reactor system; (b) a single module comprising of multiple modular units; and (c) large-scale parallel and series arrangement of multiple modules.

FIG. 3 shows results of thermodynamic calculations for ethane cracking, SMR and DMR in adiabatic isothermal and electrified conditions including (a) equilibrium conversion versus inlet fluid temperature for ethane cracking; (b) conversion versus space time for ethane cracking with feed at 1100K (˜827° C.); (c) equilibrium conversion versus inlet fluid temperature for SMR; (d) conversion versus space time for SMR with feed at 1000K (˜727° C.); (e) equilibrium conversion versus inlet fluid temperature for DMR; (b) conversion versus space time for DMR with feed at 1100K (˜827° C.).

FIG. 4 is a graph showing reaction time scale versus conversion at various fluid temperatures for ethane cracking.

FIG. 5 is a graph conversion versus space time for ethane cracking at various process temperatures for certain parallel wires configuration disclosed herein.

FIG. 6 shows various views of a single parallel-wires module.

FIG. 7 is graphs illustrating profiles of conversion, solid temperature and fluid temperature for ethane cracking with certain parallel wires configuration disclosed herein including (a) temporal profiles at the exit; and (b) spatial profiles at t=10 s.

### DETAILED DESCRIPTION OF THE INVENTION

Several heating options may be considered for replacing industrial scale gas-fired heating by electrical heating. Such electrically heated furnaces, including those described herein, has the advantage of generating heat without reliance on a particular fuel source due to the fungibility of electricity. The present inventions disclosed herein have a further advantage of aiding in achieving the goal of carbon neutrality by having the option of using electricity sourced from renewable fuels. Advantages of specific embodiments will be further described below.

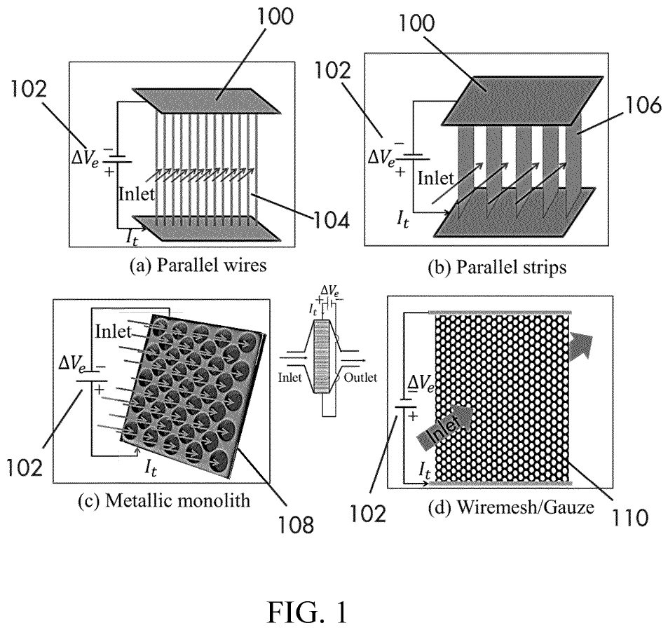

According to some embodiments of the present invention, various novel reactor configurations (shown in FIG. 1) allow for carrying out endothermic reactions producing value-added chemicals, where the required heat is supplied using electric power. The systems disclosed herein facilitate lower CO₂ emissions than conventional systems, and even emission-free operation, when utilizing electricity generated via renewables. Representative configurations of certain embodiments are shown in FIG. 1 including configurations based on modular units consisting of (1) Parallel Wires (“PW”), (2) Parallel Plates (“PP”), (3) Short Metallic Monoliths with low aspect ratios (“SM”), and (4) Wire-mesh or gauze reactors. These configurations are suitable for a wide range of homogeneous gas phase endothermic reactions including but not limited to pyrolysis or cracking of ethane, naphtha or other hydrocarbons. In some embodiments, the heating elements (e.g. wires or plates etc.) can also be coated with a thin layer of catalytic material to facilitate other endothermic reactions such as reverse water-gas shift (RWGS), dry methane reforming (DMR), steam methane reforming (SMR) reactions. Certain configurations can also be used for these and other similar endothermic reactions including methane pyrolysis, ammonia decomposition and various adsorption-desorption processes, with or without catalysts. In addition, some embodiments may include modular units further enabling ease and flexibility in scaleup.

The term reactor configuration as used herein should be understood to comprise any industrial installation suitable for industrial scale reactions and process heating.

The traditional furnace-based heating for reactor units are based primarily on radiative heat transfer where the radiative heating is described by Stefan-Boltzmann's law for radiation. The first principle calculations based on Stefan-Boltzmann's law suggest that a heating element (with emissivity of 0.4 and at temperature of 1065° C. can transfer 22 kW·m⁻² of heat energy to a reactor tube at 950° C. However, the actual heat transfer mechanism is much more complicated, as not only direct radiation applies. A first direct radiation mechanism includes radiating heat from the heating elements to the reactor tubes. A second radiating body is present in the form of the hot face wall of the furnace. In turn, the hot face wall may be heated by the electrical heating elements. The third heat transfer mechanism occurs by means of (natural) convection. Gases in the furnace rise near the heating elements and drop near the reactor tube. The fourth heat transfer mechanism occurs through radiation of the heated gases in the furnace. The relatively small contribution thereof depends on the selected gaseous atmosphere.

Contrary to the traditional furnace-based heating described above, in the proposed configuration, the heat transfer is based on the resistance heating where the heat is transferred to the reactant/product mixture directly from an electrical heating element via conduction and radiation.

FIGS. 1(a) and (b) illustrate embodiments of the PW and PP configurations, respectively, of the presently disclosed novel reactor configurations including a pair of wall portions 100 electrically connected to a power source 102. In FIG. 1(a), the PW configuration includes a set of parallel wires 104 spanning the zone between the two wall portions 100. In this embodiment, the parallel wires 104 serve as heating elements via resistance heating utilizing the electricity provided by the power source 102. Alternatively, in FIG. 1(b), the PP configuration includes a set of parallel plates 106 that similarly serve as heating elements via resistance heating utilizing the electricity provided by the power source 102. Similarly, FIGS. 1(c) and (d) illustrate SM and wire mesh configurations, respectively of the presently disclosed novel reactor configurations including a power source 102. In FIG. 1(c), the SM configuration includes a metallic monolith 108 electrically connected to the power source 102 such that the metallic monolith 108 serves as a heating element via resistance heating utilizing the electricity provided by the power source 102. In FIG. 1(d), the wire mesh configuration includes a wire mesh 110 electrically connected to the power source 102 such that the wire mesh 110 serves as a heating element via resistance heating utilizing the electricity provided by the power source 102.

In each of the four embodiments shown in FIG. 1, gases flow through the heating elements and come into direct contact with said heating elements causing heat to be conducted from the heating element to the gaseous system. Similarly, the direct radiative heat transfer occurs from the heating element to the gaseous system due to the temperature difference between the two. The higher the temperature difference, the higher the heat is transferred through radiation. The direct heat transfer from the heating element to the gaseous system are utilized in the gas conversion processes with minimal heat loss, leading to higher heating efficiency as compared to the traditional furnace-based configurations described above. The heat transfer and mass transfer with reactions/heating in proposed reactor configuration are described by the species and energy balance equations.

Several options for providing electrical heat to a process are available and can be considered according to the present disclosure.

Many different types of electrical resistance heating elements exist, each having their specific application purpose. In some embodiments of the presently disclosed configurations, reasonably high temperatures may be achieved by, for example, mineral insulated wire technology. In some configurations, at least one electrical heating element comprises a NiCr, NiCu, NiCrFe, MnNiCu, CrAlSiCFe, NiCoMnSiFe, NiAlTi, SiC, MoSi₂, or FeCrAl based resistance heating elements. Additional materials may be used to construct the electrical heating elements for the presently disclosed system based on the needs and parameters of the specific embodiment.

Nickel-chromium (NiCr) heating elements may be used in the reactor configurations disclosed herein and are used in many industrial furnaces and electric household appliances. The material is robust and repairable (weldable), available at medium costs and in various grades. However, the use of NiCr is limited by a maximum operating temperature at approximately 1100° C., considering the lifetime of the heating elements.

Another option for use in the reactor configuration and the high temperature application of the present disclosure are silicon carbide (SiC) heating elements. SiC heating elements can achieve temperatures up to 1600° C. and is commercially available up to diameters of 55 mm. This allows design of modules with large diameters as well as a high heating duty per element. In addition, the costs of SiC heating elements are relatively low.

Still another option for use in the reactor configuration and the high temperature application of the present disclosure are molybdenum disilicide (MoSi₂) elements have the ability to withstand oxidation at high temperatures. This is due to the formation of a thin layer of quartz glass on the surface. A slightly oxidizing atmosphere (>200 ppmO₂) is needed to maintain the protective layer on the elements. At temperatures 1200° C. the material becomes ductile while being brittle below this temperature. After having been in operation the elements become very brittle in cold conditions and thus are easily damaged. The MoSi₂ heating elements are available in various grades. The highest grade can operate at 1850° C., allowing use in a large range of high temperature gas conversion processes. The electric resistivity of the elements is a function of temperature. However, the resistance of these elements does not change due to aging. Only a slight reduction in resistance occurs during the first use period. Consequently, failed elements can be replaced without having impact on the other connected elements when installed in series. An advantage of MoSi₂ elements is the high surface loading of up to 350 kW·m⁻².

According to a preferred embodiment, FeCrAl (Fecralloy) is a preferred electrical heating element. FeCrAl resistance wire is a robust heating technology, because of its resistivity and ease in coating. The duty can be controlled by means of relatively ‘simple’ on/off control. High voltages can be applied to deliver the heating duty. However, this is not commonly applied as it puts extra load on the electrical switches and requires suitable refractory material to provide sufficient electrical insulation. Additionally, Fecralloy heating elements have favorable lifetime and performance properties. It is capable of operating at relatively high temperature (up to 1300° C.) and has a good surface load (˜50 kW·m⁻²). Fecralloy heating elements are capable of being used in an oxidizing atmosphere (>200 ppm O₂) to maintain an Al₂O₃ protective layer on the elements.

The highest temperature that can be achieved in the reactor configuration of the present disclosure is mainly limited by the type of heating elements that is used. According to certain embodiments of the reactor systems disclosed herein, the reactor configuration is designed to have a reactor temperature of at least 200° C., preferably from 400 to 1400° C. or 500 to 1200° C., even more preferred from 600 to 1100° C., depending on the type of reactions and reactor system. For example, preferred range of reaction temperature for homogeneous cracking of ethane may be 650-1050° C. while for homogeneous methane decomposition may be 1750-2100° C. Similarly, for steam-methane reforming, the preferred temperature ranges for catalytic process may be between 400-850° C. depending on the type of catalyst used. In general, the use of catalyst can push to the preferred range towards lower temperature values and the amount of reduction depend on the type of catalyst and reaction system. For example, the preferred range of reaction temperature for ammonia cracking is 850-950° C. with Ni-catalyst but 550-700° C. for Cs—Ru catalyst.

The heating elements used in the presently disclosed systems can have different kinds of appearances and forms, like round wires, flat wires, twisted wires, strips, rods, rod over band, etc. The person skilled in the art will readily understand that the form and appearance of the heating elements is not particularly limited and (s)he will be familiar with selecting the proper dimensions.

According to some embodiments the PW configuration depicted in FIG. 1(a) may comprise a plurality of electrically conductive wires 104 spanning the distance between two side wall portions 100 and configured such that the wires 104 are substantially parallel. The wires 104 may be configured as a single electrical circuit across all wires in the single modular unit or may be alternatively configured such that each individual wire operates as a standalone circuit. In some embodiments, the wires 104 may have a length of 0.1-10 m, 1-9 m, 2-8 m, or 3-7 m. Additionally, the wires 104 may be configured to have a diameter between 10-500 μm or 100-400 μm; and offer the flexibility of 3-4 orders of magnitude in power generation or voltage/current specifications For example, according to one embodiment, applying a current of 1200 A to a wire having a resistivity of 10⁻⁶Ω·m and the dimensions of 0.5 m in length and a 500 μm diameter will generate 3.67 MW. According to an alternative embodiment having a length of 10 m and a diameter of 50 μm, the power generated will be 7.34 GW, which is 2000 times more than that of the prior embodiment. It should be noted that the desired length of each wires 104 can also be obtained by connecting shorter wires in series, enabling the flexibility to satisfy mechanical and thermal stabilities. For example, wire of 1 m length can be obtained by connecting 10 wires of 0.1 m length in series, or 20 wires of 0.05 m length in series. Similarly, flexibility in electrical property of the wire (i.e., choice of metals where resistivity can vary from 10⁻⁹-10⁻⁵Ω·m) can provide two additional orders of magnitude variation in the same.

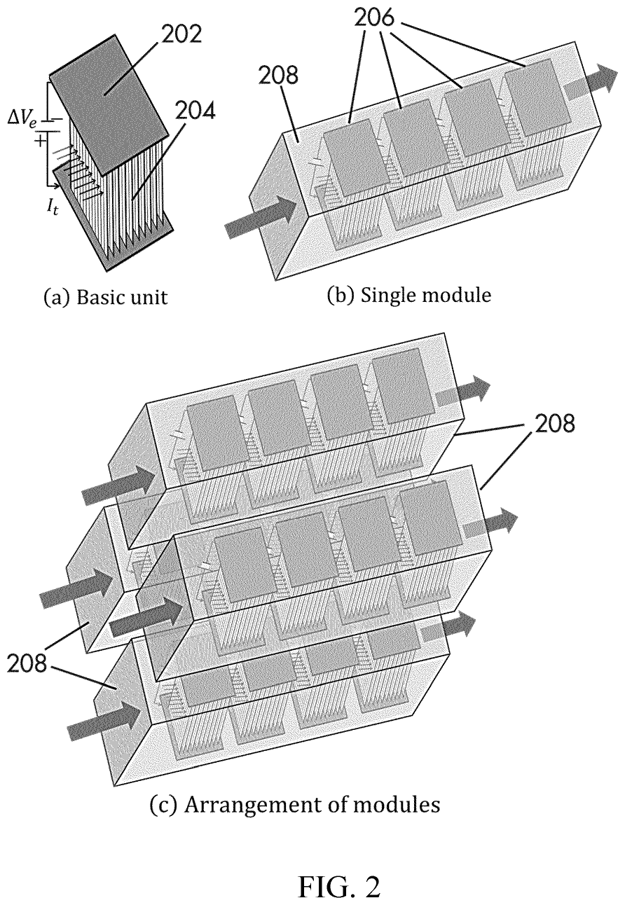

According to some PW configurations of the present invention, an overall system may include a plurality of modular units, each modular unit comprising of multiple layers of parallel wires, where each wire is subjected to the same potential difference while feed gases are flowing between the wires. FIG. 2(a) depicts one representative configuration for a single-layered modular unit. As shown in FIG. 2(a), a single unit may comprise wall portions 202 and layers of parallel wires 204 where a plurality layer of wires may also be arranged in staggered way to reduce the effective hydraulic radius. As shown in FIG. 2(b), individual modular units (such as those disclosed in FIG. 2(a)) 206 may be placed along the flow direction of a reaction zone (or heating zone) 208 to optimize real-estate footprints. Such reaction zone (or heating zone) 208 is referred to herein as a PW module. According to some embodiments, in a PW module, each unit may be subjected to a fixed voltage difference independently, so as to allow for a tailored heat injection rate and satisfy the electrical constraints (i.e., limitation on maximum voltage and/or current).

The PW configurations are particularly advantageous over prior art systems as they provide for (i) uniform heating, and (ii) additional flexibility in the design space, in particular, the choice of space time, inlet conditions (temperature, composition), wire spacing (or ratio of solid to flow volumes), number of wires per module etc. provide further flexibility that can be used to satisfy the production target and electrical/mechanical constraints for a given system. Furthermore, PW configurations can be arranged in multiple spatial directions, enabling the optimal use of real estate footprints for a given production target.

As mentioned above, unlike prior art systems, the PW configurations disclosed herein provide uniform heating to a reactant passing through the modular unit. Prior art technologies for endothermic chemical reaction processes typically include internal flow of reactants through a tube or packed-bed reactor configurations (for homogeneous and catalytic reactions, respectively) where heat is supplied via radiant heat transfer to the outer tube wall by burning fossil fuel in a furnace. Therefore, the heating efficiency in these configurations is lower because of the addition of thermal resistances (furnace to the external solid surface and external to the internal solid surface) before heat is provided to the fluid phase. Contrary to these prior art systems, in the presently disclosed configurations heat is supplied to the reactant by electrical power (preferably using renewable electricity sources) by generating the heat uniformly in a solid reactor component material, which directly supplies the heat to the fluid phase, minimizing additional thermal resistances and thus leading to potentially higher overall thermal efficiency of the reactor.

In certain prior art systems, reactor dimensions (such as hydraulic radius of the flow channels) are larger. For example, in traditional tube reactors, the diameter of the tube is order of an inch, which leads to the larger temperature gradient (or difference between solid and fluid phase), resulting in lower heating efficiency. According to the systems disclosed herein, the hydraulic diameter in the flow channels (e.g., wire spacing in PW configuration, plate spacing in PP configuration and diameters of the holes in SM/wiremesh/gauze reactor configuration) is small, such that the diffusion and conduction times are much smaller as compared to space time in the prior art design. Thus, the arrangement is such that transverse mass Peclet number (pₘ) and transverse heat Peclet numbers pₕ, defined by

$${p}_{m} = \frac{{t}_{Dm}}{{t}_{c}} = \frac{〈 u 〉 {R}_{Ω}^{2}}{{D}_{m} L} ; \qquad ( 1 )$$

$${p}_{h} = \frac{{t}_{Dh}}{{t}_{c}} = \frac{〈 u 〉 {R}_{Ω}^{2}}{{α}_{h} L} ;$$

$${t}_{Dm} = \frac{{R}_{Ω}^{2}}{{D}_{m}} ;$$

$${t}_{c} = \frac{L}{〈 u 〉} ;$$

$${t}_{Dh} = \frac{{R}_{Ω}^{2}}{{α}_{h}} ,$$

may be smaller than unity. Here t_{Dm}, t_{Dh} and t_{c} are the characteristic diffusion, conduction and space times, respectively; [symbol] u [symbol] is the average velocity of the feed; R_{Ω} is the hydraulic radius;

$${α}_{h} = \frac{{k}_{f}}{{ρ}_{f} {C}_{pf}}$$

is the thermal diffusivity (with k_{f}, ρ_{f} and C_{pf} being thermal conductivity, density and specific heat capacity of the fluid phase); L is the length of the channel. In addition, in order to get the significant conversion of the reactant the Damkohler number Da, defined as the ratio of space time to reaction time as

$$Da = \frac{{t}_{c}}{{t}_{R}} = \frac{L R ( {c}_{ref} , T )}{〈 u 〉 {c}_{ref}} = \frac{L {k}_{R} ( T )}{〈 u 〉} ( for linear kinetics ) \qquad ( 2 )$$

is chosen much greater than unity. For example, it can be in between 5-10 or between 1-100, or higher than 100. Here t_{R} is the reaction time, c_{ref} is reference concentration, R(c_{ref}, T) is the rate of reaction. For the case of linear kinetics, the reaction time

$${t}_{R} = \frac{1}{{k}_{R}} ,$$

where k_{R} is the reaction rate constant. The reaction time may depend on concentration (or system pressure) but depends strongly on operating temperature. In our configuration, the conditions pₘ, pₕ<1 and Da>>1 could be satisfied to increase the heating efficiency while achieving higher conversion.

In some embodiments a transverse gradient in temperature may be present such that the gas near the wire is hotter than the gas at the centerline. In such systems, higher conversion rates may be obtained near the solid surface while lower conversion may be found at the centerline. Some embodiments implement staggered stacking of wire-layers to further enable more efficient and uniform heat supply thereby leading to more efficient cracking by subjecting the colder feed (from one layer) to have closer vicinity to the wire surface in the next layer (effectively reducing the apparent hydraulic radius). Additionally, flexibility of stacking the layers or multiple units in flow direction may additionally provide for reducing the total height of each module without losing the productivity while staying within the electrical constraints. Accordingly, the modular systems disclosed herein may be designed to conform to spatial requirements for the specific deployment in a wide variety of reactor systems.

The simplest reduced order mathematical model describing the material and energy balance for both catalytic and homogeneous reactions for certain embodiments of the PW and other configurations (e.g., PP, monolith, wiremesh, gauze) can be represented in terms of multiple concentration and temperature modes, corresponding to their averages in the fluid and solid phases, and interfacial heat/mass fluxes. The transverse gradients can be captured using transfer coefficient concepts, which lead to accurate results for the case of homogeneous and/or catalytic reactions. The only differences include (i) the interfacial heat fluxes including the radiation terms either through effective transfer coefficient or directly through the Stefan-Boltzmann's equation, (ii) the source term representing the electrical resistance heating in the solid phase, and (iii) the sink term representing the endothermic heat required for gas conversion process.

For certain embodiments of the PW configuration, the solid phase heat source term in the modeling for the systems disclosed herein can be represented as

$${\dot{Q}}_{h} = \frac{1}{{ρ}_{e}} {( \frac{Δ V}{L} )}^{2} \qquad ( 3 )$$

In this heat source term, \dot{Q}ₕ, ρₑ, ΔV and L represent the electrical power generated per unit solid volume, electrical resistivity of the wire, potential difference applied across the wire and the length of the wire, respectively.

In some embodiments, the modular reactor segments comprise a set of parallel plates 106 as shown in FIG. 1(b). In such embodiments, a voltage difference is applied across the length of the plate 106 while feed gases flow along the width. This configuration has the similar advantage as the PW configuration in terms of the width of the plate 106. Equivalently, the number of layers stacked in PW arrangement is similar to the ratio of width to the thickness of plates in PP arrangements. Similar to the embodiment of one PW module illustrated in FIG. 2(b), one embodiment of a PP module may comprise multiple PP units in series, providing for similar advantages. According to some embodiments, having longer length in flow direction in PP arrangement may require higher electric power for same productivity, which may exceed beyond the current-voltage limitation for a unit. Therefore, stacking such units in series (similar to PW configuration as shown in FIG. 2(b)) provides flexibility to stay within electric constraints.

The reduced order mathematical model for a PP configuration can be either the multi-mode non-isothermal short monolith reactor model or the long monolith models, depending on the axial Peclet number. The heat source term in this configuration is also given by Eq. (3) as described above in reference to the presently disclosed PW configurations.

In another configuration, short monoliths (or thin plates with holes—short channels) 108 are used as one unit (shown in FIG. 1(c)), while one module may consist of several of such SM units stacked in flow direction. In such embodiments, the feed gases flow internally through the short channels while potential difference is applied perpendicular to the flow along one of the sides of the plate. The mathematical model is the multi-mode non-isothermal short monolith reactor model, where the heat source in this case can be represented as follows:

$${\dot{Q}}_{h} = \frac{1}{{ρ}_{e}} {( \frac{Δ V}{{L}_{T}} )}^{2} \cdot \frac{1}{f ( {γ}_{s} )} \qquad ( 4 )$$

where L_{T} is the length of one of the sides across which voltage difference is applied, γₛ is the volume ratio of solid to fluid, and f(γₛ) is the geometric factor representing the dimensionless effective resistivity due to the presence of holes in the plate.

In wiremesh configuration, one unit may be composed of a single wiremesh 110 as shown in FIG. 1(d) or a plurality wiremesh 110 stacked in flow direction, while one module may consist of multiple such units stacked in the flow directions. Each unit may be subjected to the same potential difference along one of the sides as in SM configuration. Thus, feed gases flow through one wiremesh then others, where partial conversion takes place in each mesh, leading to the desired conversion at the outlet of the last mesh. The mathematical model for flow and reaction through each wiremesh or gauze is same as that of the short monoliths. The heat source term may also be the same as that of certain SM configurations disclosed herein (Eq. 4), where the channel length in SM unit is equivalent to number of wiremesh times wire thickness in wiremesh unit.

### Results

While the configurations disclosed herein may be utilized with any endothermic process, the performance metrics may be modeled using the exemplary endothermic process of ethane cracking for ethylene production. In addition, we select the PW configuration as a proxy for demonstration as it provides additional flexibility of being able to stack in the flow direction and ease in evaluation of electrical constraints. The examples disclosed herein are calculated examples using the models disclosed herein.

### Thermodynamic and Kinetic Aspects of Ethane Cracking and Other Endothermic Reactions

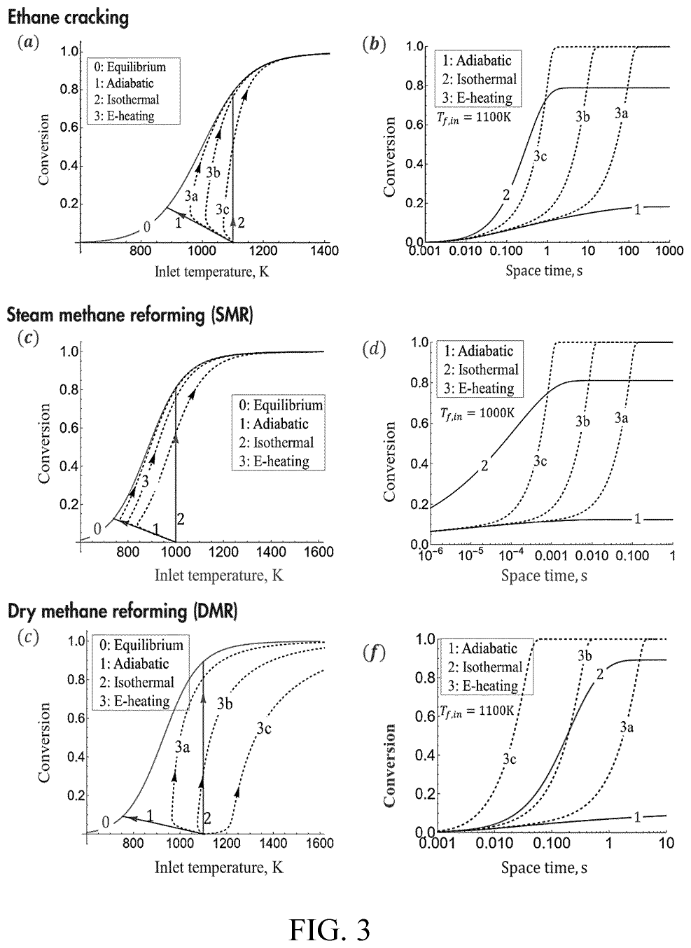

Initial design considerations were given to thermodynamic calculations based on reaction thermochemistry in order to accurately estimate the process conditions and equilibrium constraints for the systems disclosed herein. Based on the standard thermodynamic data, FIGS. 3(a), (c) and (e) depict the calculated maximum (equilibrium) conversion possible for certain reactor configurations disclosed herein as a function of operating temperature for ethane cracking, SMR and DMR, respectively. As shown in these figures, when operating temperature is increased, conversion increases (which is typical of reversible endothermic reactions). This is expected as the equilibrium constant for an endothermic reaction increases exponentially with the operating temperature. Therefore, when desired conversion is high, higher operating temperature in the reactor is required, which may pose additional material/safety related constraints. Therefore, such calculations play an important role in material screening to assure safe operation.

FIGS. 3(a), (c) and (e) also illustrates the difference between adiabatic, isothermal and electrified operations for ethane cracking, SMR and DMR respectively. For example, in isothermal operation (where heat is being supplied to maintain the temperature constant in the reactor), conversion may reach the equilibrium value as shown by the isothermal reaction path. In contrast, in adiabatic operation (where no heat is supplied), as the reaction proceeds, the reacting fluid cools as the reaction consumes the sensible heat of the fluid, leading to a decrease in the temperature and corresponding decrease in the conversion (see the adiabatic reaction path). On the contrary, in electrified operation (where Joule's heating is supplied through the electric power), depending on the space time and power being supplied, the conversion may start along the adiabatic path and then follows the path towards equilibrium, and eventually, may lead to higher conversion (almost 100%) in the end. This is because heat is being supplied continuously and operating temperature may increase beyond the target isothermal temperature, leading to much higher conversion. In these figures, the dashed curves (3a, 3b and 3c) correspond to the cases when the electric heat supplied are in the ratio of 0.02:1, 0.2:1 and 2:1, respectively as compared to the endothermic heat requirement to maintain isothermal operation (at target operating temperature). For example, for some embodiments designed for ethane cracking having an inlet fluid temperature of 1100K (˜827° C.), the equilibrium conversion may be roughly 80%, which may be achieved in isothermal operation by maintaining reactor temperature constant through the heat supply. However, adiabatic operation with the same inlet feed temperature leads to a lower conversion of 18% with final temperature reduced to 883K (˜610° C.). In the electrified operations with feed at 1100K, while it may initially follow the adiabatic path resulting in lower temperature (depending on electric power supplied and space time), it may result in fluid temperature higher than the feed, resulting in conversion higher than 80%. Similar trends are observed for other endothermic processes such as SMR and DMR shown in FIGS. 3(c) and (e).

While the equilibrium conversion versus temperature relation is obtained solely based on thermodynamic considerations, the results illustrated by FIGS. 3(a), (c) and (e) apply only to a closed system (corresponding to space time approaching infinity or flow rate going to zero). For open systems, the actual conversion obtained at any given space time depends on the reaction kinetics, operating conditions (temperature as well as mode of operation) and flow distribution and will be lower than the equilibrium conversion. The steady-state conversion may be calculated using available kinetic models for these endothermic processes. For demonstration purposes, the kinetics of ethane cracking, SMR and DMR here are selected from conventional methods to perform thermodynamic and conversion calculations. FIGS. 3(b), (d) and (f) show the equilibrium conversion versus space time for ethane cracking (with feed at 1100K˜827° C.), SMR (with feed at 1000K˜727° C.) and DMR (with feed at 1100K˜827° C.), respectively. It can be seen from these figures that the conversion that is close to the equilibrium value may be achieved with a smaller space time in the isothermal operation and relatively larger space time for the adiabatic operation. For example, for ethane cracking, with feed at 1100K (˜827° C.), conversion close to equilibrium value (i.e., ˜80%) may be achieved with space time of 2 s in isothermal operation and 100 s in adiabatic operation as shown in FIG. 3(b). Similarly, for SMR, with feed at 1000K (˜727° C.), conversion close to equilibrium value (i.e., ˜80%) may be achieved with space time of 2 ms in isothermal operation and 10 ms in adiabatic operation as shown in FIG. 3(d). For DMR, with feed at 1100K (˜827° C.), conversion close to equilibrium value (i.e., ˜90%) may be achieved with space time of 1 s in isothermal operation and 10 s in adiabatic operation as shown in FIG. 3(f). In addition, these figures also depict the conversion from electrified operation achieved with various space times. Two key points to note from these figures are (i) depending on the space time and electric heating supplied, the conversion in electrified operation can result into higher value (even close to 100%) than the isothermal operation (of course resulting in higher fluid temperature as well), and (ii) higher the electric power supply, lower is the space time required for same target conversion. Thus, with a given temperature limit (related to material constraints), the target production rate can be potentially achieved with electrified operations, as long as electric and other process constraints are given into considerations. It should be noted that depending on the temperature of the feed entering the heated section, there may be small conversion, which may alter the starting point slightly in FIG. 3, but final conclusions are not altered.

The space time requirement as well as process temperature are important design parameters necessary to consider to achieve the desired level of conversion. While FIGS. 3(a), (c) and (e) provide partial information (conversion and temperature relationship), they do not estimate specific space time requirements. However, they provide the tentatively target fluid temperature for desired conversion. Similarly, FIGS. 3(b), (d) and (f) provide the tentative space time for a particular target fluid temperature (1100K or 1000K). For example, FIG. 3(b) shows that for embodiments with a target fluid temperature of 1100K (˜827° C.) in ethane cracking, 80% conversion requires space time to be about 2 s. Similarly, when desired conversion is 50% with target fluid temperature of 1100K (˜827° C.), the suggested space time is about 0.3 s. In other words, higher desired conversion requires larger space times, as can be expected intuitively, so that the reactant will have enough contact time for conversion.

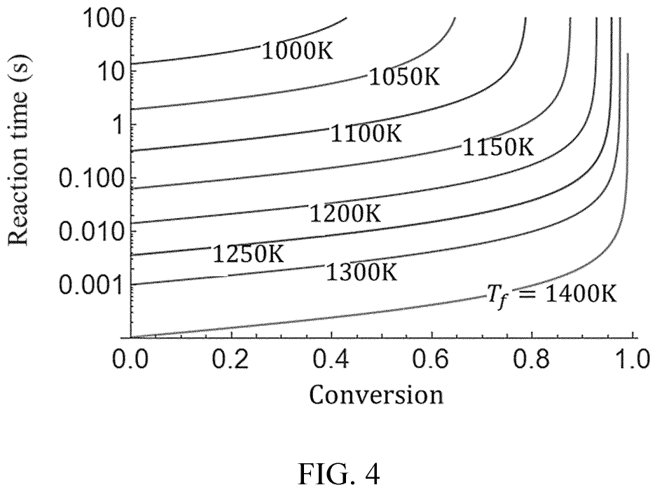

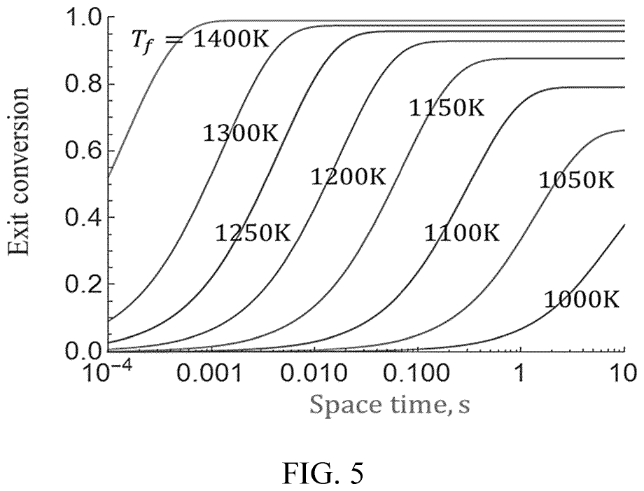

The selected target values of space time and operating temperature must also satisfy the two criterions (pₕ<1 and Da>>1) as discussed above to obtain higher conversion with higher heating efficiency. This requires the evaluation of diffusion times as well as reaction times. The characteristic reaction time can be obtained from the reaction rate expression at various temperatures and conversion levels. FIG. 4 shows the reaction times at various temperature and conversion for ethane cracking. This plot shows that the reaction times can vary 6 orders of magnitude depending on fluid temperature. Similarly, FIG. 5 shows the conversion versus space time for ethane cracking for parallel wire configuration (in the same manner as FIG. 3 but at various other temperatures). These plots (shown in FIG. 5) also suggests that at a given target temperature, there is a maximum limit on conversion that can be achieved regardless of how large the space time is. This maximum limit corresponds to the equilibrium value as shown in FIG. 3(a). These figures (FIGS. 3, 4 and 5) can be used to select the design and process parameters so that the Damkohler number is greater than unity to achieve higher conversion and to refine the target temperature as well as corresponding space time. Similar calculations can be performed for any other endothermic reactions, where FIGS. 3-5 may change quantitatively but the nature and qualitative features remain the same.

Some embodiments of the presently disclosed systems can be designed such that the difference between solid and fluid temperature can be limited within 50 to 100° C., as contrasted to the prior art technology where such difference can be from (100 to 400° C.). Thus, based on the material susceptibility, maximum solid temperature may be selected to assure safe operations—leading to a rough estimate of fluid temperature. Once a target fluid temperature is selected, the reactor model with intermediate levels of mixing (depending on the reactor configuration and design of each module) may be utilized to obtain one of the important design parameters—space time. An appropriate value of space time can be used to determine the reactor volume based on the desired production capacity of the reactor for a desired conversion.

### Power Requirements and Voltage/Current Constraints

The power requirement (\dot{Q}ₜ) for carrying out an endothermic reaction depends on the flow and reaction parameters such as flow rate, reactant concentration (and/or pressure) inlet/exit temperature, which constitutes of sensible heat of the feed and heat of reaction. Sample calculations are disclosed herein using the example of ethane cracking.

### Power Requirement Based on Endothermic Chemistry and Flow Conditions

For the example of ethylene production from ethane cracking, the power requirement (\dot{Q}ₜ) can be expressed as follows:

$${\dot{Q}}_{t} = {F}_{in} [ {C}_{pf} ( {T}_{f} - {T}_{fin} ) + ΔH ] \qquad ( 5 )$$

where Fᵢₙ, C_{pf}, T_{f}, T_{fin}, ΔH and χₑ are inlet molar flow rate, specific heat capacity, exit fluid temperature, inlet fluid temperature, enthalpy of reaction and conversion, respectively. The first part is the sensible heat of the feed that is required to bring the feed from inlet temperature to the target temperature, while the second part is the heat required for obtaining target conversion from reaction.

As an example, a world-scale ethane cracking plant may have an ethylene production capacity of 1 mega ton per annum (MTA), which is equivalent to 1.13 kmol/s of ethylene production or Fᵢₙ=1.25 kmol/s of ethane feed (assuming χₑ=90% conversion). This corresponds to the volumetric flow rate of 100 m³/s of ethane feed at 1 atm pressure and T_{fin}=950K (˜677° C.). Assuming the target reaction temperature T_{f}=1300K (˜1027° C.), the space time (t_{c}) can be selected using FIG. 3(a) or FIG. 5, which suggest t_{c}=10 ms. Thus, the power requirement (\dot{Q}ₜ) can be calculated from Eq. (5), which is approximately \dot{Q}ₜ=215 MW (with C_{pf}˜140 J·mol⁻¹K⁻¹ and ΔH˜145 kJ·mol⁻¹. In addition, the total fluid volume in the reactor (V_{f}=qᵢₙt_{c}) is approximately 1 m³.

Similarly, in another example of lower capacity ethane cracker producing 250 kilo tons per annum (kTA), the power requirement, inlet flow rate of ethane, and fluid volume will be lower in proportion (for same space time and inlet/exit fluid temperature). To be specific, a 250 kTA ethylene plant (producing 283 mol/s ethylene at 1300K˜1027° C.) from ethane with feed/inlet flow rate of 314 mol/s (or 25 m³/s at 1 atm and 950K˜677° C.) may require 54 MW power. Assuming the same space time (t_{c}=10 ms), the total fluid volume for this case will be ˜0.25 m³. These numbers here are only illustrative and may change depending on the specific reaction system and feed conditions.

### Electrical Power Generation and Design of Heating Modules

When the total power required is supplied through electrical heating, it is important to operate within the electric constraints such as maximum current or voltage limitations. According to some embodiments, the electrical power (P₀) generated in a wire (of electrical resistivity ρₑ, length L and diameter d_{w}) that is subjected to a potential difference of ΔV, is given by

$${P}_{0} = \frac{π {d}_{w}^{2}}{4} \frac{{( Δ V )}^{2}}{{ρ}_{e} L} = \vert ΔV \vert \cdot {I}_{0} ; \qquad ( 6 )$$

$${I}_{0} = \frac{π {d}_{w}^{2}}{4} \frac{\vert ΔV \vert}{{ρ}_{e} L}$$

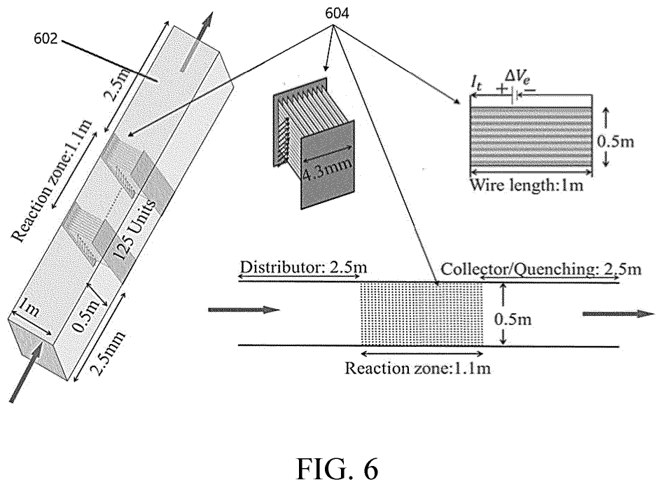

For example, applying a potential difference of 75 volt across a 1 m long wire (of 100 μm diameter and 1.4Ω·μm resistivity), leads to about 0.42 Amp current and generates about 31.56 W electrical power. Thus, if a maximum of 1200 Amp current is allowed (as one of the electrical constraints), a basic unit consisting of about 2852 such wires as depicted in FIG. 2(a) may produce upwards of about 90 kW electrical power. Therefore, to achieve 250 kTA plant capacity (requiring about 54 MW power), about 600 of such basic units will be required, which can be achieved in many combinations such as 1 module containing about 600 basic units, or 2 modules containing about 300 basic units, or 3 modules containing about 200 basic units, and so on. FIG. 6 shows the schematic of a module 602 consisting of 125 basic units 604, which may correspond to the production capacity of the module about 50 kTA. Five of such modules may be required to have the ethylene plant of production capacity of 250 kTA. The number of modules is flexible and can be selected depending on the desired production capacity and constraints on real-estate footprints. According to some embodiments, a production plant comprises between 1 and 50 modules, where each module comprises between 10-1000 basic units. These basic units can be designed and arranged in modular configuration to optimize the footprint, as well as satisfy the voltage/current constraints. For example, there is flexibility in the design of a single basic unit in terms of number of parallel wires stacked vertically in a single layer and number of layers stacked in flow direction (as shown in FIG. 2(a)). According to some embodiments, the basic PW unit (shown in FIG. 2(a)) comprises between 200 and 10000 individual parallel wires spanning the distance between two wall portions of the unit. More preferable, some embodiments of the basic PW unit may include between 100 and 10000 individual wires, and even more preferably between 2000 and 3000 individual wires. The number of wires stacked vertically in a single layer dictates the height of a unit or module, while the number of layers dictates the flow length of a unit. According to some embodiments, the average layer comprises between 10 and 5000 wires stacked vertically or preferably between 100 and 500 wires stacked vertically. According to some embodiments, a single basic PW unit comprises between 2 and 50 layers or preferably between 5 and 10 layers. Additional flexibility exists in terms of number of units stacked in a flow direction, which dictates the length and capacity of the module. The number of units can be selected based on the constraints on maximum inlet velocity and space time requirement. According to a representative embodiment utilizing the PW configuration, FIG. 6 illustrates a schematic of a module 602 with detailed arrangement of wires incorporating a plurality of PW units 604 for transient simulation and demonstrating the validity. FIG. 6 depicts multiple views of a representative embodiment of the PW unit 604 including an illustration of how the modular unit is situated in the module 602 and cross-sectional views illustrating wire configuration. In some embodiments of a system incorporating a plurality of said modular units 604, the system may comprise between 10 and 2000 individual basic PW units (as described earlier).

According to some embodiments, the configurations may include modular units of any type disclosed herein, including without limitation, PW, PP, SM, and wire-mesh configurations. The schematic of basic individual units in PW is depicted in FIG. 2(a) while those in PP, SM and wiremesh configurations are depicted in FIGS. 1(b), 1(c) and 1(d), respectively. According to some embodiments, similar to PW configurations, in other configuration also, a production plant may comprise between 1 and 50 modules, where each module may comprise between 10-1000 basic units. According to some embodiments, in PP configuration, a basic unit (shown in FIG. 1(b)) may comprise between 10 and 5000 plates stacked vertically, or preferably between 100 and 500 plates stacked vertically. Therefore, one of the key advantages of the systems disclosed herein is achieved because said systems provide for a wide degree of customization and flexibility using modular units without the need for system-wide redesign.

### Transient Behavior of Modular Units

In some embodiments of the systems disclosed herein, transient simulation can be performed to assure the realistic performance of the module based on flexible design including reactor size, process conditions, and electric parameters/constraints.

Process Parameters: To design the parameters for some embodiments disclosed herein, FIG. 3(a) can be utilized to select a target fluid temperature for desired conversion (preferably more than 80%), thereafter the appropriate space time can be selected from FIGS. 4 and 5. According to an embodiment and for exemplary demonstration of transient simulation, a target temperature of 1300K (˜1027° C.) and space time of 0.01 s (10 ms) may be selected. For this demonstration, the inlet temperature of ethane was assumed to be 950K (˜677° C.).

Geometric parameters: According to an exemplary embodiment, a PW module 602 as shown in FIG. 6, consists of 125 PW basic units 604. In such embodiment, each PW basic unit consists of 8 layers of 326 parallel wires, having total number of wires per unit is 2608. Each wire is of 1 m length, 100 μm diameter and 1.4Ω·μm resistivity. In every layer, the parallel wires are separated by 1.51 mm (i.e. approximately transverse spacing to diameter ratio is approximately 15). Each layer is separated by 0.5 mm (i.e., axial spacing to diameter ratio is five). The resulting height of each unit (which is same as the height of each module) as 0.5 m, and flow length of each unit as 4.3 mm. Assuming spacing between each unit is the same as length of the unit (i.e. ratio of spacing to length is unity), the total length of each module is approximately 1.1 m. Therefore, the dimension of the reactor part of each module is 1 m×0.5 m×1.1 m (i.e., 0.55 m³). In such embodiment, in each module, there are 125×8 (=1000) wires in the flow direction, therefore the effective solid length in the flow direction is 0.1 m requiring a velocity of 10 m/s to achieve space time of 0.01 s. Thus, the space time based on total length of the module (which is approximately 10 times larger than the effective solid length because of spacing between wires and spacing between each unit) is approximately 10 times lower, i.e. 0.1 s.

Electric parameters: In the exemplary embodiment described above, each unit is subjected to 79 volt, leading to the total current of 1157 Amp per unit (or 0.44 Amp per wire), generating 35.1 W per wire or 91.5 kW per unit of electric power. As a result, a module generates electric power of 11.44 MW and can produce approximately 52 kTA of ethylene.

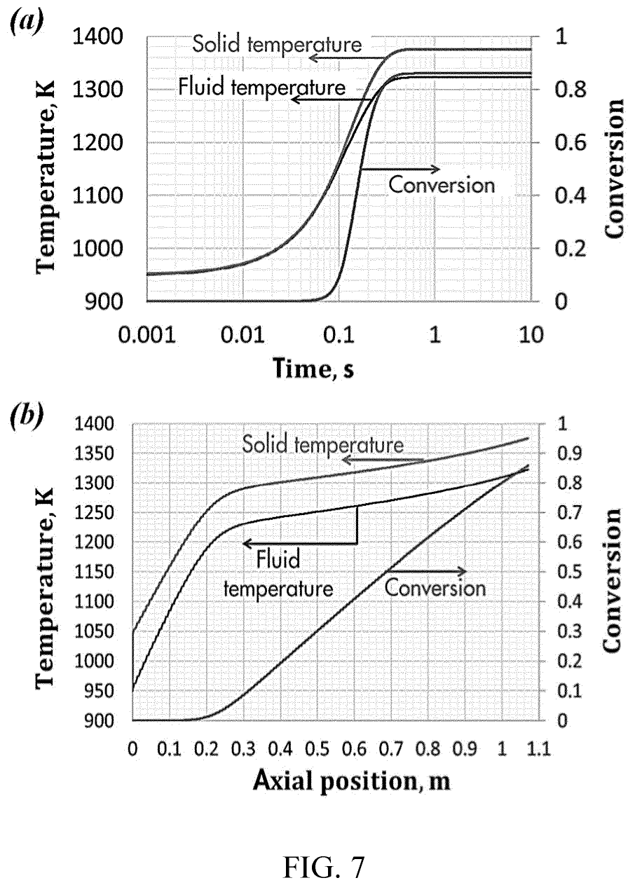

The reactor configuration can be modeled as a series and parallel combination of the two-phase short monolith model, which leads to the transient profile of temperature and conversion at the exit of the module as shown in FIG. 7(a) for inlet velocity of 10 m/s. Similarly, the spatial profile at t=10 s is shown in FIG. 7(b).

As disclosed herein according to at least this exemplary embodiment, the difference between fluid and solid temperatures is approximately 60° C. (steady-state solid and fluid temperatures at the exit are 1380K˜1107° C. and 1320K˜1047° C., respectively). In addition, according to some embodiments, the time to achieve steady-state is below 1 s, or more preferably below 0.8 s, as shown by FIG. 7(a). Such short time period to steady-state operation corresponds to fast start-up time as compared to hours to few days in conventional, prior art technologies. Additionally, the spatial profile in FIG. 7(b) illustrates that each wire leads to gradual conversion. The first few units near the inlet contribute mainly to the sensible heat to increase the temperature of the feed stream. Indeed, the space time for each wire is 10 μs, therefore conversion starts at higher temperature (approximately 1200K˜927° C.). Therefore, once temperature of the gas reaches about 1200K (˜927° C.), each wire leads to partial conversion. According to some embodiments, at the exit of the module, at least 75% conversion is achieved, with at least 80% or 85% conversion being more preferably achieved.

According to some embodiments, the modules disclosed herein achieve uniform velocity distribution across the cross-section of the module and fast quenching after exiting the wire section. Depending on the specific parameters necessary for such a module, additional reactor length (and volume) may be required for feed distribution, product collection and quenching. It is preferable to quench before collecting the feed to prevent or mitigate product loss due to additional reaction time at temperature. In the exemplary case considered where feed is flowing with a velocity of 10 m/s in a cross-section of 1 m×0.5 m and flow length of 1.1 m, the length of distributor and collection may add up to 5 m, leading to the total footprint required for each module as 1 m×0.5 m×6 m (˜3 m³). Thus, in some embodiments of a PW configuration, the volume of module with capacity of generating 11.44 MW electric power or producing approximately 50 kTA of ethylene is 3 m³.Therefore, according to some embodiments, five of such modules can produce 250 kTA of ethylene with footprint of approximately 15-20 m³, thereby utilizing a significantly smaller footprint when compared with conventional, prior art technology where the reactor volume may be of order of 1000 m³.

### Advantages of New Reactor Configurations

According to some embodiments, the reactor configurations disclosed herein have many advantages over prior art technology, particularly due to the modularity/flexibility of the units as well as the potential of coupling with renewable power.

According to some embodiments, the presently disclosed systems are based on all-electric heater (i.e., no burning of fossil fuel to supply heat as in the traditional approach), therefore these systems have the utility of providing for reduced, zero, or net negative CO₂ emission while producing value-added chemicals. Accordingly, if renewable power (such as solar, wind, geothermal, hydro, nuclear) are used to produce electricity, CO₂ emission can be reduced or even completely be eliminated. For example, prior art ethane cracking technology releases about 1.2 moles of CO₂ into the atmosphere per mole of ethylene produced. In other words, a world-class ethane cracker (producing 1000 kTA ethylene) releases approximately 1800 kTA CO₂ into the atmosphere. According to some embodiments, reduced or zero CO₂ emissions can be obtained for SMR (steam methane reforming) processes, while negative CO₂ emissions can be obtained for DMR (dry methane reforming) and RWGS (reverse water-gas shift) reactions.

According to some embodiments, the presently disclosed systems may be applied to wide variety of processes including homogeneous and catalytic reactions. The presently disclosed systems may also be applicable to a wide variety of endothermic processes including: (1) cracking of ethane, propane, naphtha, crudes etc.; (2) pyrolysis of methane; (3) steam or dry methane reforming (SMR or DMR); (4) reverse water-gas shift (RWGS); (5) ammonia decomposition; and (6) other such endothermic reactions. In some embodiments, the presently disclosed systems may be used to facilitate: (1) non-catalytic homogeneous reaction (i.e., reactions in the fluid phase); and/or (2) surface catalyzed reactions (i.e. reaction at the solid surface). For endothermic reactions requiring a catalyst, in some embodiments, the wires of the PW or Gauge or Wire-mesh configuration or the plates in PP configuration or the interior of the monolith (i.e. the interface in contact with fluid) may be coated with a thin porous layer of washcoat containing the catalytic agents (as practiced in monolithic catalytic converter used for the treatment of exhaust gases from automobiles).

The prior art technology discussed herein has a heating/thermal efficiency as low as 30-40%. For example, ethane cracking technology uses energy that is about 3 times the thermodynamic minimum required (174.4 KJ/mole). According to some embodiments disclosed herein, the direct electrical heating of tubes/wires/metallic monolith reactors may reduce the energy requirements significantly leading to heating efficiency greater than 80%, 85%, 90%, 95%, or 99%. In some embodiments, the same efficiency advantages apply to other endothermic reactions such as steam methane reforming (SMR), dry methane reforming (DMR), reverse water-gas shift (RWGS) reaction and others with CO₂ as a reactant.

According to some embodiments, the transient time in proposed technology is order of seconds (as shown in FIG. 7(a)) as compared to the traditional technique from the prior art systems that takes several hours to a day, thereby resulting in a lower startup and shutdown time. This leads to the reduced production losses while performing maintenance on the presently disclosed systems.

According to some embodiments, the systems disclosed herein include a modular providing for flexibility and ease of scale-up. The presently disclosed reactor configurations are modular and provide significant flexibility by allowing for size up the system based on local (preferably renewable) energy availability and process constraints including voltage-current limitations. In particular, some embodiments of the disclosed PW systems provide flexibility in terms of process, material and geometric parameters, to comport with various constraints related to production, space, capital cost, and current/voltage limitations. For example, according to some embodiments of the present invention specifically designed for ethane cracking using PW modules, the space time can be selected in the range of 0.1-1000 ms (preferably 0.1-300 ms, and more preferably 1-100 ms); the inlet temperature can be as low as 800K (preferably as low as 700K, and more preferably as low as 600K) to as high as 1100K (preferably as high as 1200K, and more preferably as high as 1300K); length of each wire can vary in the range 0.25-4 m (preferably 0.5-2 m) depending on the production target; wire diameter can be selected between 25-750 μm (preferably between 50-500 μm); the spacing between the wires can be between 0.1-20 mm (preferably between 0.1-10 mm); the number of wires of each unit can vary between 10 to 10000 (preferably between 50 to 5000, and more between 500 to 3500), the range of resistivity of the wire material can be 10⁻⁹ to 10⁻⁵Ω·m, which spans various metals (including, but not limited to, the materials disclosed herein); and the solid volume fraction can be chosen between 1-30% (preferably between 1-20%).

In addition, in some embodiments, each module can be stacked in parallel or series independently providing the flexibility in scale-up design. In some embodiments of PW arrangements, a module may comprise of multiple layer (or set) of parallel wires stacked along the flow direction. Such stacking may also be arranged in staggered fashion, which can reduce the effective spacing between the wires, leading to better heat transfer between the solid and fluid. In some embodiments, the proposed systems allow for independent arrangement of each module in the plant to achieve the targeted upscale production smoothly as discussed above. Since each module can be arranged in any direction, the target upscaled production may be achieved by stacking modules in parallel and/or series in any direction. The number of such modules depend on the target production (as discussed earlier). For example, according to an exemplary embodiment, a PW module 602 as shown in FIG. 6, a 1000 kTA ethylene plant may require 200 of such modules, a 100 kTA ethylene plant may require 20 of such modules, and a 400 kTA ethylene plant may require 80 modules. When heating efficiency is low, the number of modules may be increased accordingly to achieve the target production. For example, if heating efficiency is reduced from 100 to 80%, the number of modules required in 400 kTA ethylene plant may increase from 480 to 100. These modules may be stacked along the flow or perpendicular to the flow depending on the availability of the space. The flexibility in selection of process parameters and material/geometric properties can also be used to optimizing real-estate footprints to satisfy the space constraints.

Due to the modularity of the presently disclosed configurations, such systems facilitate ease in safety and maintenance checks, as well as replacement and accommodation of new safety/mitigation strategies with negligible extra operating cost. For example, in some embodiments, if a safety issue arises, or a maintenance/safety check is needed, the entire module is not required to be put through shutdown or startup cycles (as required in traditional, prior art approach). Instead, the modular design enables the shutdown of small sections (or specific modules) while leaving others in operation. Similarly, the replacement of faulted modules can be performed same way, which leads to much lower production losses and higher operational capital utilization. Accommodation of new mitigation strategy is simplified. For example, the coke formation mitigation methodologies (based on magnetic or electromagnetic pulses or high frequency vibrations) can be easily incorporated to prevent coke formation due to the thermal cracking and similar processes.

In some embodiments, the all-electric heater design proposed in the presently disclosed configurations provides for uniform temperature distribution, contrary to the prior art combustion furnace designs that utilize radiant fuel burners. In addition, combustion furnace designs require (˜80%) higher localized temperatures to effectively heat the walls of the reactor to the target temperature, whereas the presently disclosed electric heater configurations facilitate an increase in the targeted wall temperature directly through controlled Joule heating. This results into more uniform temperature distribution thereby providing more consistent, uniform reaction conditions along with higher heating efficiency and longer system lifetimes.

1. A modular reactor system for carrying out endothermic reactions comprising:
a. At least one module, each module further comprising
i. A plurality of wall sections positioned to encompass a reaction zone inside a channel configured to allow a fluid to flow through the reaction zone;
ii. A power source; and
iii. At least one resistance heating element passing through the reaction zone in mechanical connection with the wall sections and in electrical connection with the power source;
iv. Wherein the at least one resistance heating element is in electrical isolation from the wall sections;
v. Wherein the reactor system is configured to allow for the flow of a fluid containing one or more reactants;
vi. Wherein the reaction zone is suitable for conversion of the reactants to products when reactants are present in the fluid;
b. Wherein the resistive heating element of each module is configured to generate resistance heating in the reaction zone such that its temperature can be adjusted to a required reaction temperature range;
c. wherein the at least one resistance heating element comprises a configuration selected from a group consisting of a plurality of wires, a plurality of plates, wiremesh, gauze, and a metallic monolith.
d. wherein the at least one resistance heating element comprises a plurality of wires;
e. wherein each of the wires is parallel to the other wires;
f. wherein the wires each have a length between 0.1 m and 10 m;
g. wherein the wires each have a diameter of between 10 μm and 1000 μm; and
h. wherein the wires have a resistivity between 10⁻⁹Ω·m and 10⁻⁵Ω·m

2. (canceled)

3. The modular reactor system of claim 1
a. wherein the at least one resistance heating element comprises a plurality of metal plates; and
b. wherein each of the plates is parallel to the other plates.
c. wherein the plates have a length (in perpendicular direction to the flow) between 0.1 m and 10 m and width (along the flow) between 50 μm and 5000 μm:
d. wherein the plates have the thickness between 10 μm and 1000 μm; and
e. wherein the plates have a resistivity between 10⁻⁹Ω·m and 10⁻⁵Ω·m.

4. The modular reactor system of claim 1
a. wherein the at least one resistance heating element comprises a wiremesh, gauze, or a metallic monolith: and
b. Wherein the wiremesh, gauze, or metallic monolith has a hydraulic radius between 50 μm and 10000 μm.
c. Wherein a single wiremesh, gauze, or metallic monolith unit has an axial flow length between 50 μm and 5000 μm.

5. The modular reactor system of claim 1
a. wherein the modules are configured to allow for a plurality of modules to be arranged in parallel and/or series configurations; and
b. wherein the plurality of modules is configured to allow the fluid to flow through the reaction zone of each module.

6. The reactor system of claim 1 wherein the at least one resistive heating element is configured to generate resistance heating in the reaction zone resulting in a temperature of at least 200° C.

7. The reactor system of claim 1 wherein the at least one resistive heating element is constructed from a material selected from a group consisting of FeCrAl, NiCr, SiC, MoSi₂, NiCu, NiCrFe, MnNiCu, CrAlSiCFe, NiCoMnSiFe, and NiAlTi

8. The reactor system of claim 1 further comprising
a. a plurality of resistance heating elements;
b. wherein the resistance heating elements are arranged such that the species diffusion and the heat conduction times from fluid to solid is smaller than the space time; and
c. the resistance heating elements are selected such that the transverse heat Peclet number is less than unity.

9. The modular reactor system of claim 1 wherein the system is configured to facilitate ethane cracking, propane cracking, naphtha cracking, methane pyrolysis, ammonia decomposition, dry or steam reforming of methane, reverse water-gas shift, adsorption-desorption processes, and/or mixtures thereof.

10. The modular reactor system of claim 1 wherein the at least one resistive heating element further comprises a catalyst.
